(19) United States
(12) Patent Application Publication
(10) Pub. No.: US 2009/0299815 A1
(43) Pub. Date: Dec. 3, 2009

(54) SYSTEMS AND METHODS FOR VALUATION SERVICES INFORMATION MANAGEMENT

(76) Inventors: Kurt S. Lewis, Oak Hill, VA (US); Indira Korrapati, Charlotte, NC (US)

Correspondence Address: Weiss & Arons, LLP, 1540 Route 202, Suite 8, Pomona, NY, 10970, US

(21) Appl. No.: 12/131,228

(22) Filed: Jun. 2, 2008

(51) Int. Cl. G06Q 10/00

(52) U.S. Cl. 705/10; 705/1

(57) ABSTRACT

Systems, methods and consumer-readable media for valuation services information management are provided. A method according to the invention may include the following steps. A first step may include receiving a request for a valuation service that includes a group of multiple properties. The request may then be validated. The validation may be based on prior requests. The method may also include determining whether the request allows providing valuations of the properties instead of more rigorous appraisals. If valuations are allowed the method may allow the direct award of the valuations to a valuation provider for completion. If valuations are not permitted, then the method may further include transmitting a request for proposal (“RFP”) regarding the request for appraisals for multiple properties to a plurality of appraisal providers. Bids from the valuation service providers may be received in response to the RFP. Reviews of the received bids may then be received. A selection of a appraisal provider may then be received.

### FIELD OF TECHNOLOGY

Aspects of the disclosure relate to managing valuation services information. As defined herein, valuation services may be understood to include commercial real estate appraisal services, residential real estate appraisal services, enterprise valuation services, environmental due diligence and/or a suitable commercial real estate evaluation—i.e., less formal evaluations of real estate for transactions that are exempt from Federal regulatory appraisal requirements.

### BACKGROUND

Conventional processes for requesting valuation services typically include sending out requests for proposals for selected valuation tasks. Even projects with multiple properties are typically created and tracked as separate assignments. Furthermore, job managers (sometimes referred to “procurement specialists”) on the requesting side typically must enter data elements manually from reports into databases after the job managers have received the appraisal orders.

Moreover, evaluation services tax assessments cannot be evaluated against market data for accuracy in real time, thereby requiring these assessments to be audited after-the-fact—i.e., post evaluation process. This requirement for after-the-fact auditing reduces value to the requesting entity.

Accordingly, it would be desirable to provide improved systems and methods for valuation services information management.

### SUMMARY OF THE INVENTION

It is an object of this invention to provide improved systems and methods for valuation services information management.

A method according to the invention may include the following steps. A first step may include receiving a request for a valuation. The request may then be validated. The validation may be based on prior requests. The method may further include transmitting a request for proposal (“RFP”) regarding the request for valuation service to a plurality of valuation service providers. Bids from the valuation service providers may be received in response to the RFP. Reviews of the received bids may then be received. The selection of a valuation service provider may then be finalized. The method may further include adjusting the appraised price of the property in response to market conditions.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows an illustrative flow diagram of a high level loan fulfillment process according to the invention;

FIG. 3 shows an illustrative flow diagram of an environmental risk management process according to the invention;

FIG. 4 shows an illustrative flow diagram an evaluation services report process;

FIG. 5 shows an illustrative flow diagram that compares a real estate appraisal process to a real estate evaluation process;

FIG. 6 shows in illustrative flow diagram of a process for using a web-based system according to the invention;

FIG. 7 shows a screen shot that may form part of a system according to the invention;

FIG. 8 shows another screen shot that may form part of a system according to the invention; and

FIG. 9 shows yet another screen shot that may form part of a system according to the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

One embodiment of a Valuation Services Information Management System according to the invention is a web-based sourcing solution that organizes valuation services in order to successfully manage a wide array of real estate and enterprise valuation assignments, among other projects. An embodiment of the invention preferably streamlines sourcing processes, improves process control, and enhances regulatory compliance.

The system according to the invention may support at least the following functions in Valuation Services groups—Commercial Real Estate Appraisal, Commercial Real Estate Evaluation Services, Real Estate Environmental Due Diligence Services and Enterprise Valuation Services—that provide collateral valuations and related due diligence in support of commercial real estate and commercial leveraged transactions.

Aspects of the invention may relate to workflow management. Such aspects may include implementing an automated job manager that handles assignments using configurable business rules, using web-based sourcing for all third-party products and services (Request For Proposal (RFP), Award, Contract Management), integrating business partner contract approvals, utilizing manual/automated electronic communications with business partners and suppliers, improving portfolio management tools—e.g., consolidating large, repetitive projects into a single virtual project for forwarding to an appraisal provider—and exploiting data integrity validation processes.

Other aspects of the invention relate to document management. Such aspects include using XML data extraction for third-party reports (such as reports provided by a commercial provider such as First American Commercial Real Estate Services (“FACRES”) or other suitable entity), increasing bandwidth from valuation service providers to receivers in order to support larger files, and improving document access at the receiver side.

Yet other aspects of the invention relate to knowledge management. These aspects may include data-mining of key information to support underwriting, trend analysis, etc.

Aspects of reporting according to the invention may include role-based presentation of time-sensitive data and performance metrics. The reporting according to the invention may further include query capabilities to analyze data.

Other aspects of the invention may relate to information security. Such aspects may include improved security protocols for third-party suppliers (internet-based) and reduced reliance on external tools for communication and data collection.

With respect to system administration, aspects of the invention may include system tools that reduce reliance on technical support and improved system configuration flexibility that enables a system update without further programming.

Systems and methods according to the invention provide the ability to manage portfolios with multiple properties in a single request. For example, if an entity were to evaluate 500 stores in a fast-food chain, the system preferably would allow the entity to send a request that bundles the requests for the appraisals of all the 500 stores into a single request. The request would then be processed at the receiving end by the appraisal provider as 500 single requests, but the administrative overhead on the requesting entity has been significantly reduced.

Furthermore, embodiments of the invention may allow service and property type to preferably dynamically drive data input criteria. Accordingly, a choice of selectable criteria may be presented to a requesting entity such that, the appraisal criteria may be changed in some predetermined fashion, based on the type and/or quality of service or property being appraised.

Another aspect of the invention may reduce the manual data input of appraisal data elements by job managers by allowing suppliers to enter the information. For example, by providing a platform for the appraisal data to be entered in XML language or some other suitable language by the appraiser, the requesting entity may be provided with appraisal information that is in a simplified and validated format.

Systems according to the invention further provide the ability to set up property and market multipliers for tax assessments. The following example illustrates how this feature may preferably improve the accuracy of appraisals.

Tax assessments are often used as a component of real estate evaluations. However, adjustments to tax assessments often lag behind market changes—i.e., the value of property in the market changes more rapidly than the tax assessment for the corresponding property. Further, the accuracy of tax assessments across various commercial property types—e.g., office, industrial, retail, etc.—may vary considerably. Accordingly, the tax assessments may provide sub-optimal information for use in creating real estate evaluations. One method according to the invention of reducing the risk associated with over-valued tax assessment based-evaluations is to adjust the information in the tax assessment using a property value multiplier that takes into account market trends and other market forces specific to that property type. In addition, the market multiplier may take into account market forces and trends specific to that geographic location. The property and market value multiplier may preferably be adjusted to incorporate the preferably most recently available changes to the market value of the property into the value obtained from the tax assessment. Thus, the tax assessment as adjusted according to the invention significantly reduces the risk of over-valuation associated with select property types in select locations, thereby improving its utility as a valuation tool for underwriting.

One additional aspect of the invention relates to providing an automated evaluation review. The systems and methods of the invention may include reviewing the values obtained from suppliers (or other internal methods of obtaining values) prior to providing the values to the requesting entity. The review may be based at least in part on a statistical analysis of market norms and trends.

In short, the invention preferably provides an ability to manage portfolios with multiple properties using a single request, select data input criteria based on service and property type, reduce the manual data input of appraisal data elements by job managers by allowing suppliers to enter the information, provide an ability to set up property and market multipliers for tax assessments, and set up thresholds for property tax assessment values so that a review for use by a job manager can be automatically generated.

These systems and methods preferably reduce operational risk attributed to the supplier, reduce data entry and processing time for projects with multiple properties, reduce manual transposing of data from supplier reports, improve data accuracy, and reduce data import processing time from valuation services support for portfolio with multiple properties because the supplier of the valuation information can upload the data at the supplier end.

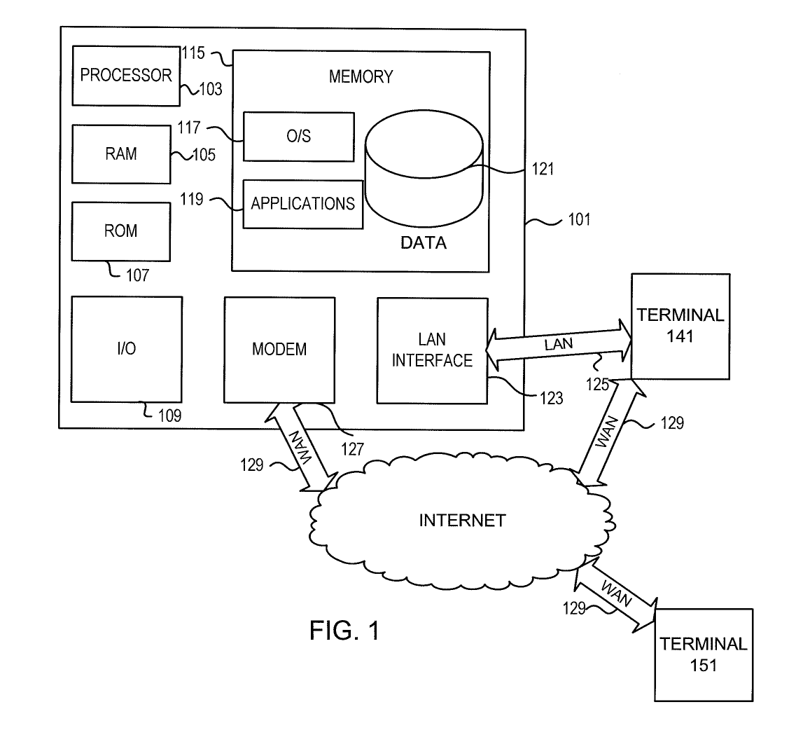

FIG. 1 illustrates a block diagram of a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide centralized storage of account information and account holder information for the entire business, allowing interoperability between different elements of the entity residing at different physical locations.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119 used by server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

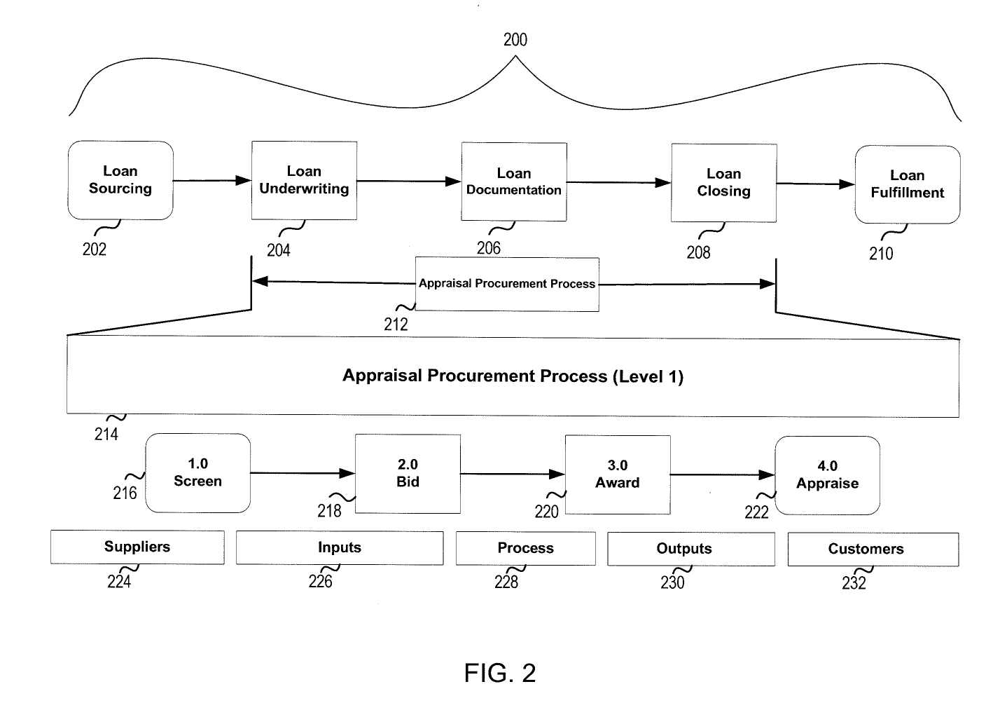

FIG. 2 shows an illustrative flow diagram of a high level loan fulfillment process 200. This process may be implemented within any of a number of lines of businesses (“LOBs”) and/or entities. Examples of such entities include small business, middle markets, commercial real estate banking, private banking, etc.

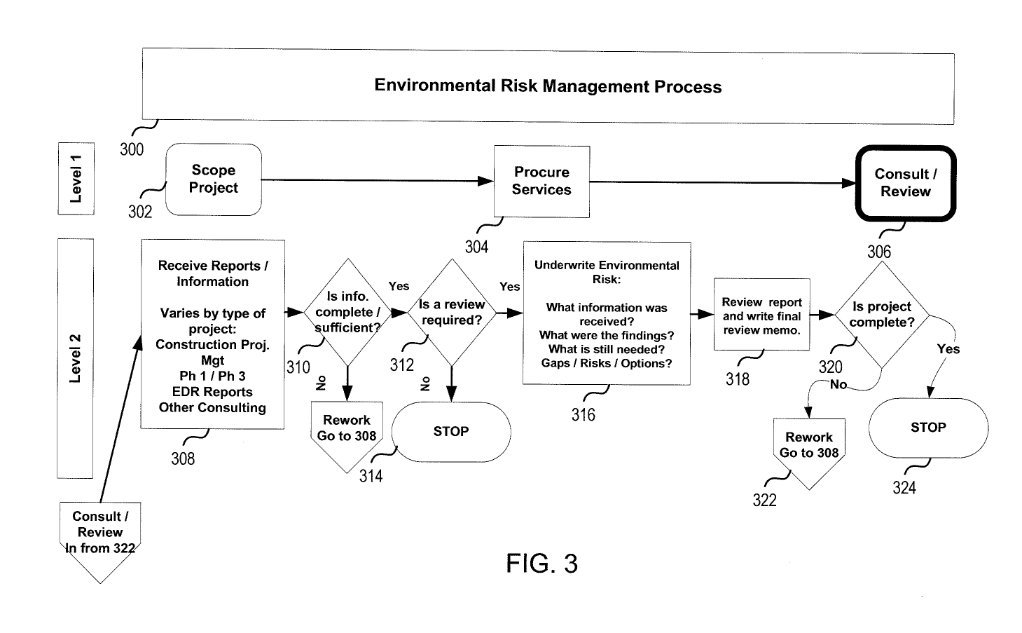

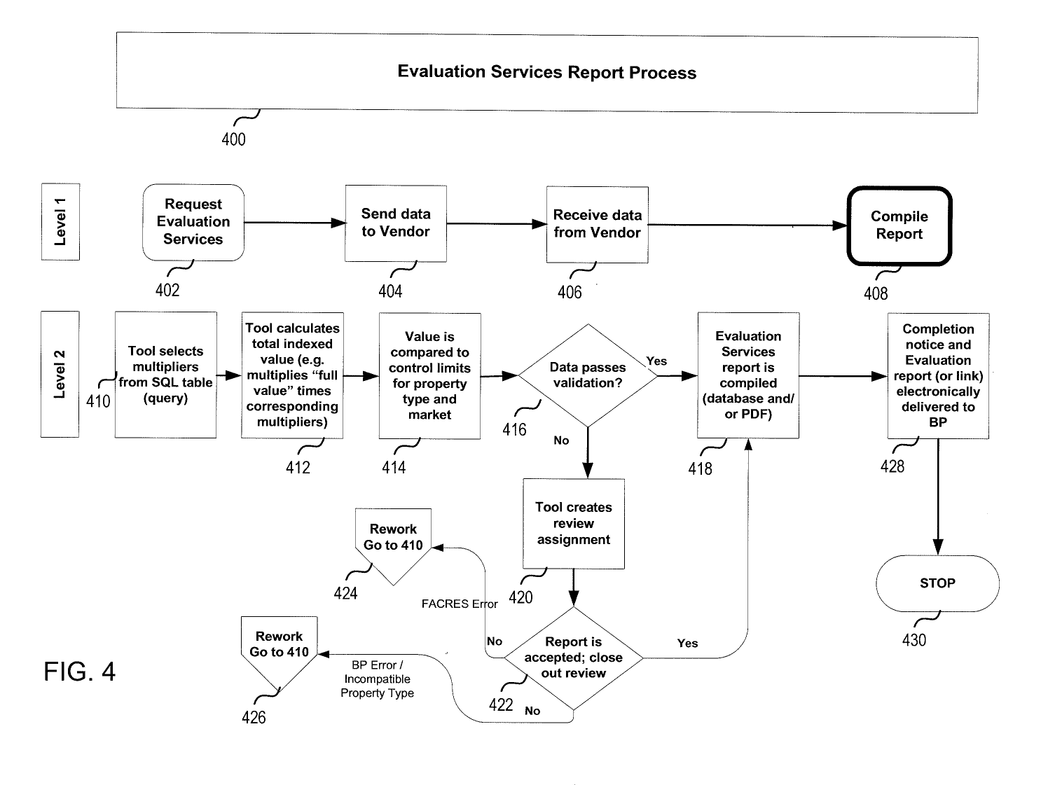

Process 200 preferably includes loan sourcing 202, loan underwriting 204, loan documentation 206, loan closing 208, and loan fulfillment 210. Typically, the appraisal procurement process 212/214, or other suitable valuation process as shown in FIGS. 3 and 4, may occur between loan underwriting 204 and loan closing 208, although the appraisal procurement process can occur for reasons other than loan origination.

Appraisal procurement process 212/214 may include providing a screen to configure a particular appraisal 216, sending out requests for bids to possible candidates 218, awarding the bid to an appraisal provider 220, and receiving the appraisal from the appraisal provider 222.

Appraisal procurement process 212/214 may include the following components: data and/or information suppliers 224, data inputs 226, process aspects 228, outputs 230 and users/customers 232. Data suppliers 224 may include borrowers that supply data; an LOB(s) that supplies transaction data, underwriting data, and/or documentation; appraisal suppliers; regulatory agencies; systems and methods according to the invention that supply data; and third-party applications used to process invoices.

The actual data input into the system via data inputs 226 may include LOB data, borrower data, bids from appraisal suppliers, real estate expertise, regulatory data, entity policy data, internal policy data, suppliers requirements, appraisal reports and invoices.

The implementation of the process aspects 228 of the invention may include providing a screen-based request for bids for appraisals, submitting bids, awarding bids to an appraisal provider and reviewing the appraisal results.

Outputs 230 from the system may include requests for proposals provided to appraisal entities, engagement contracts for finalizing relationships between the requesting entities and the appraisal providers, status update e-mails, appraisal reports, appraisal reviews, project management reporting, and invoice payments.

Users 232 of the appraisal procurement process may include LOBs, borrowers, appraisal providers, entity leadership, regulatory/compliance personnel, and/or entity shareholders.

FIG. 3 shows an illustrative flow diagram of an environmental risk management process 300. Process 300 may also be implemented between loan underwriting step 204 of FIG. 2 and loan closing step 208, or other scenario as may be appropriate. It should be noted that process 300 is typically not Federally regulated unless the project under scrutiny is a securitized project.

Level 1 of process 300 includes a determination of the project scope 302, procuring services for the project 304, and consulting/reviewing the project results 306.

In the more detailed level 2 of process 300, the project scope is determined based on reports and/or information regarding the project 308. It should be noted that Level 2 of process 300 is typically specific—i.e., occurs as part of—the consult/review sub-process 306. The reports and information obtained in step 308 may differ depending on whether the environmental risk management is for a construction project, for an environmental site assessment Phase I, II, or III,¹ or some other suitable environmental report. ¹ A Phase I Environmental Site Assessment Report (ESA) is a third-party investigation performed in general conformance with ASTM Standard E1527; Phase II is an ESA which involves invasive investigation including drilling, soil testing, etc. Phase III involves the contracting of services to remediate contamination or other negative environmental conditions.

At step 310, the reports and/or information are reviewed to determine whether the information is complete 310. If the information is not complete, then the process loops back to step 308. The process may also query whether a review of the retrieved information is required 312. If a review is not required, then the process may be terminated at 314.

If a consultation or review is required, then the process may continue to the procure services portion 304. Portion 304 may include queries relating to underwriting environmental risk. Such queries may include:

What information was received?

What were the findings?

What is still needed? Gaps in the information/Risks determined in response to the information/Options in view of risks?

As the process moves to consult/review portion 306, the review may require reviewing the report and preparing a final review memo 318. The consult/review portion of the process may then determine at 320 whether the project is complete. If process 300 is not complete 322, process 300 loops back to 308. If the project is complete, then process 300 terminates 324.

FIG. 4 shows an embodiment of an evaluation services report process 400 according to the invention. Process 400 may also be implemented between the loan underwriting step 204 of FIG. 2 and the loan closing step 208, or other scenarios as may be appropriate.

Level 1 of process 400 preferably includes requesting evaluation services 402, sending data to an evaluation services vendor 404, receiving data from the vendor 406 and compiling a report based on the data 408.

The more detailed level 2 of process 400 preferably includes a tool that selects appropriate multipliers, such as property and market multipliers described above, using SQL (structured query language) queries, as shown at step 410. It should be noted that the more detailed level 2 of process 400 typically occurs as part of the compilation sub-process 408. The tool can calculate the total indexed value by, for example, multiplying the assessed value of the property by the corresponding multipliers 412. It should be noted that the implementation of the tax assessment multiplier and other multipliers can be a separate process that is not necessarily sequentially linked to providing evaluation services reports. Multipliers may be updated periodically on a schedule based on when the data required to form the multiplier is published.

Step 414 shows that the value of the property is validated by comparing the adjusted value (or, alternatively, the unadjusted value) of the property to preferably pre-determined control limits for property type and market. The method may then query at 416 whether the data passes validation. If the data fails validation, then the tool may create a review assignment to review the data at 420. If the report is accepted at 422, then the review is closed out. If the report is still not accepted, then the report may be reworked either because of a supplier error or a business partner error which can result from an attempt to evaluate an incompatible property type or improperly identified property.

When the data passes validation or the report is accepted, the evaluation services report can be compiled and stored in a database or stored and/or forwarded as a PDF 418. Finally, a completion notice and evaluation report (or link) can be electronically delivered to the business partner. Then, process 400 can be terminated.

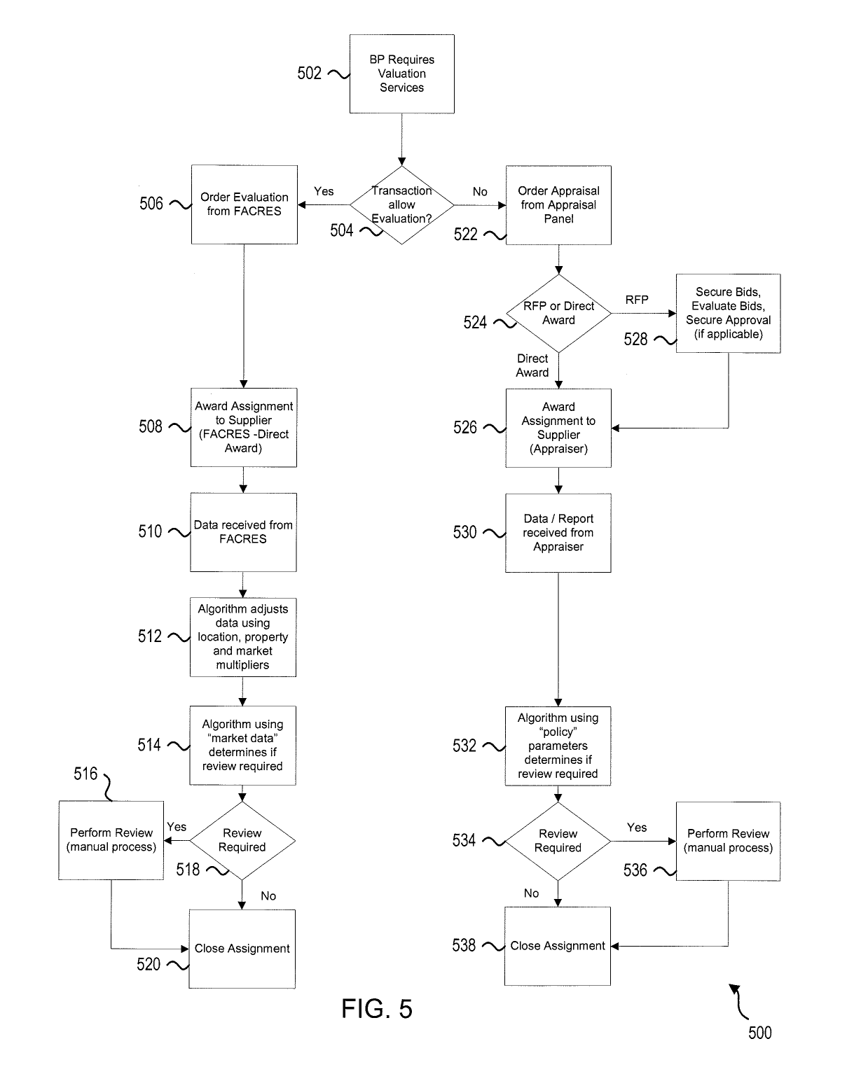

While process 400 shows an evaluation process for quickly determining an estimate of the value of a property, a more rigorous process is the real estate appraisal process. FIG. 5 shows an illustrative flow of a process 500 that may utilize either the more rigorous real estate appraisal process to the less rigorous real estate evaluation process.

Step 502 shows that process 500 initiates with a requirement by a business partner of valuation services. Step 504 queries whether the requested transaction allows for the less-rigorous evaluation.

If the transaction allows for evaluations, then an evaluation is ordered from FACRES, at step 506. Step 508 shows an award of an assignment to the supplier such as FACRES, using a direct award (as opposed to an RFP) method.

Upon receipt of the evaluation from FACRES 510, step 512 shows an algorithm adjusting the data using location, property, and/or market multipliers. A second algorithm using market data may determine if further review of the evaluation is required 514.

If review is required, then review may be performed at 516. This review may be performed by a manual (or automated) process. If no review is required, then the assignment may be closed at 520.

If the process determines in response to query 504 that the transaction does not allow an evaluation, then an appraisal is ordered from the appraisal panel, at step 522. The process may query whether such an appraisal should be ordered via an RFP or a direct award. If the appraisal is ordered via a direct award than the appraiser is assigned the task of providing an appraisal, as shown at 526. If the appraisal is ordered via an RFP, bids may be secured and evaluated and an approval of the bids may be returned.

In either method (526 or 528) the award is assigned to an appraiser. The data/report may be received from an appraiser at 530. Thereafter, an algorithm may use predetermined parameters to determine whether further review of the appraisal is required, as queried at 534. If review is required, then review may be performed, at step 536. If review is not required, or successfully completed then the assignment may be closed at 538.

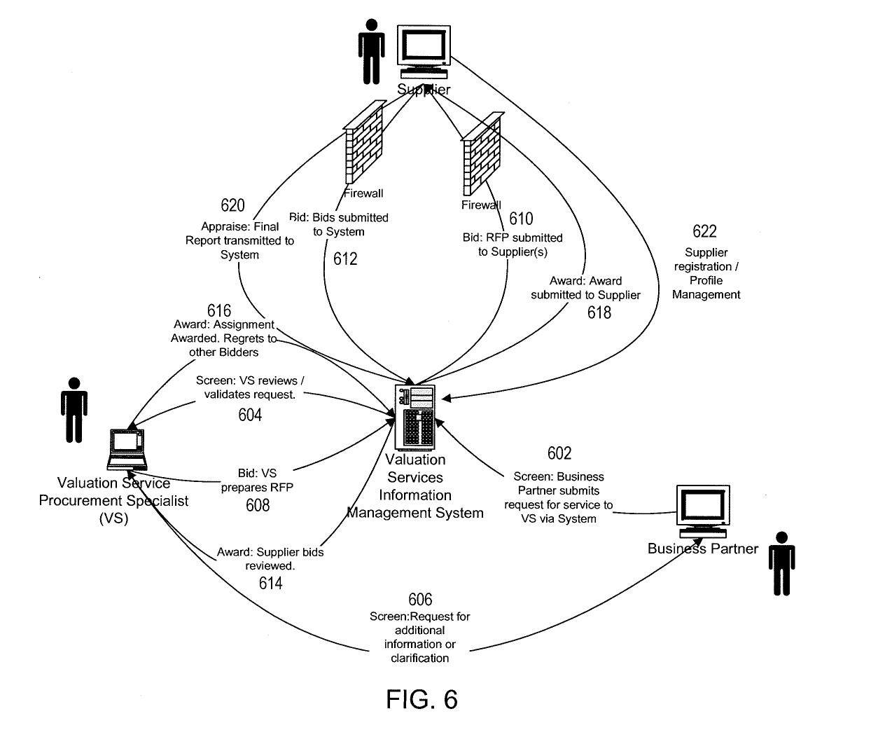

FIG. 6 shows an illustrative flow diagram of a process for using a web-based system according to the invention. Step 602 shows that a business partner or other interested entity may use a web screen to submit a request for service to a valuation service procurement specialist within the same entity as the business partner. This request may be submitted via the valuation service information management systems.

Thereafter, the system sends the request to a valuation service procurement specialist at 604. The valuation service procurement specialist may review and validate the request for valuation services. Then the valuation service procurement specialist may prepare an RFP and transmit the RFP to the system at 608. The valuation service procurement specialist may also request additional information directly from the business partner at 606 or via the system.

The system may then take the RFP submitted by the valuation service procurement specialist and forward it to the valuation service supplier at 610. There may preferably be a firewall between the system and the supplier as the supplier is typically outside the entity network.

The supplier may submit a bid, again preferably through a firewall, to the system at 612. The system may forward received bids to the valuation service procurement specialist at 614. Then, the assignment is selected at 616 by valuation service procurement specialist, and regrets may be transmitted to the other bidders.

The assignment may be awarded to the supplier, as shown at 618. The appraisal and final report may be transmitted back to the system at 620. It should be noted that a separate step of supplier registration/profile management is shown at step 622. Step 622 preferably forms a part of the control and administration of valuation suppliers as implemented by the system.

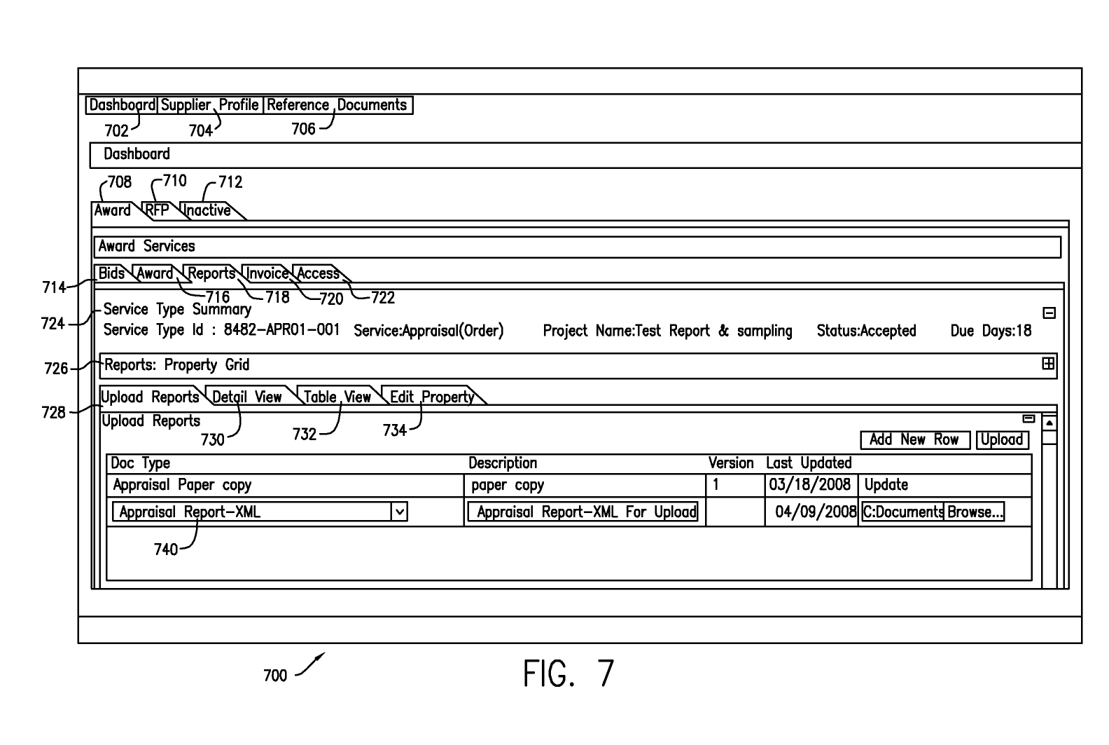

FIG. 7 shows a screen shot 700 that may form part of a system according to the invention. Screen shot 700 may preferably include dashboard button 702, supplier profile button 704, and reference documents button 706. FIG. 7 preferably shows the dashboard including tabs for the award 708, the RFP 710, and for inactive matters 712.

Screen shot 700 also shows the award services which includes tabs for bids 714, awards 716, reports 718, invoices 720, and access 722. Reports may include two sections: a service type summary 724 and a reports section 726. Tabs for reports section 726 include an upload reports tab 728, a detail view 730, a table view 732, and an edit property view 734. The upload reports view is shown. This view may include a field such as “document type” which may specify such documents as an appraisal report, as well as a description of the document, a version, and a date that the document was last updated, an add new row option button and an upload button.

In order to input information into the system shown in FIG. 7, the following steps may be taken.

1) the Supplier selects the document type 740 as “Appraisal Report-XML” and uploads the XML version of the document that he is inputting.

2) The system can then parse the XML using the attached document and validate the uploaded document.

3) If there were any validation errors, then an alert message can be shown to the user with the validation error.

4) If the XML validates correctly, the entries are updated in the database and a success message can be shown to the supplier.

5) The Supplier can then see the information in the Property 734/Table View 732/Detail view 730 pages.

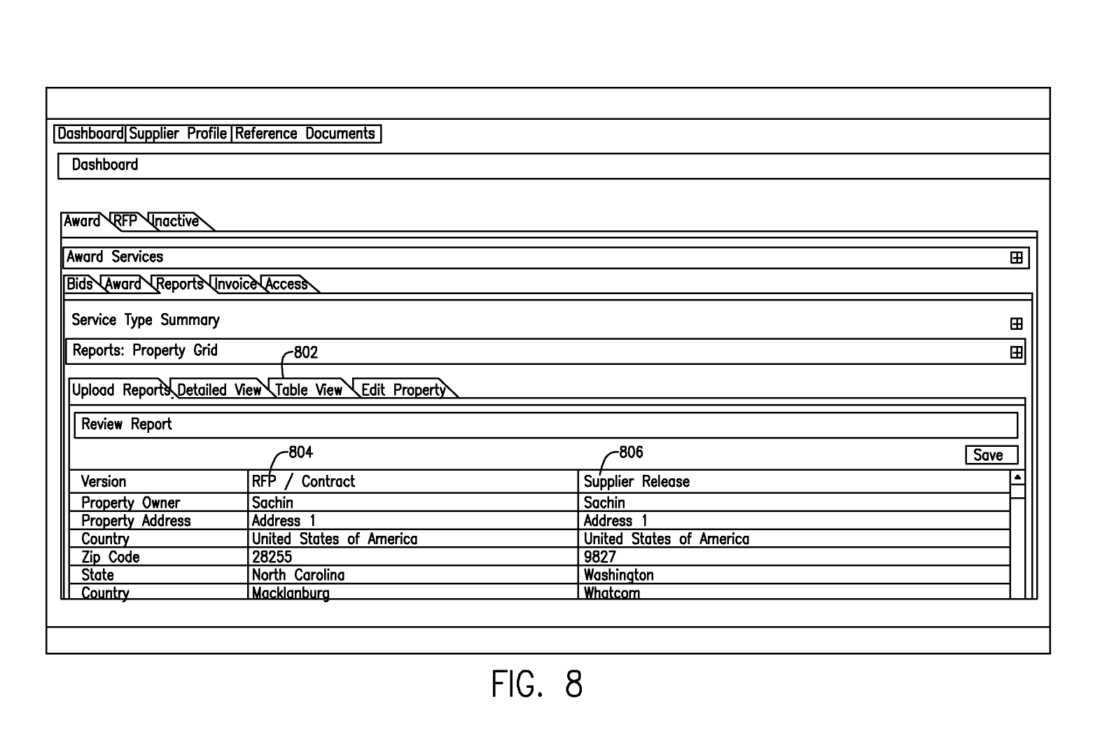

FIG. 8 shows a table view 802 as selected based on tab 732 in FIG. 7. The other elements have not been specified in FIG. 8, because as they are substantially the same as the elements in FIG. 7. Rather, the main difference in FIG. 8 is that screen shot 800 includes table view 802 of the review reports.

Table view 802 preferably includes an RFP/Contract section 804 that specifies the property being appraised. Table view 802 also preferably includes a supplier release 806 that specifies the supplier that has prepared and released the report being reviewed.

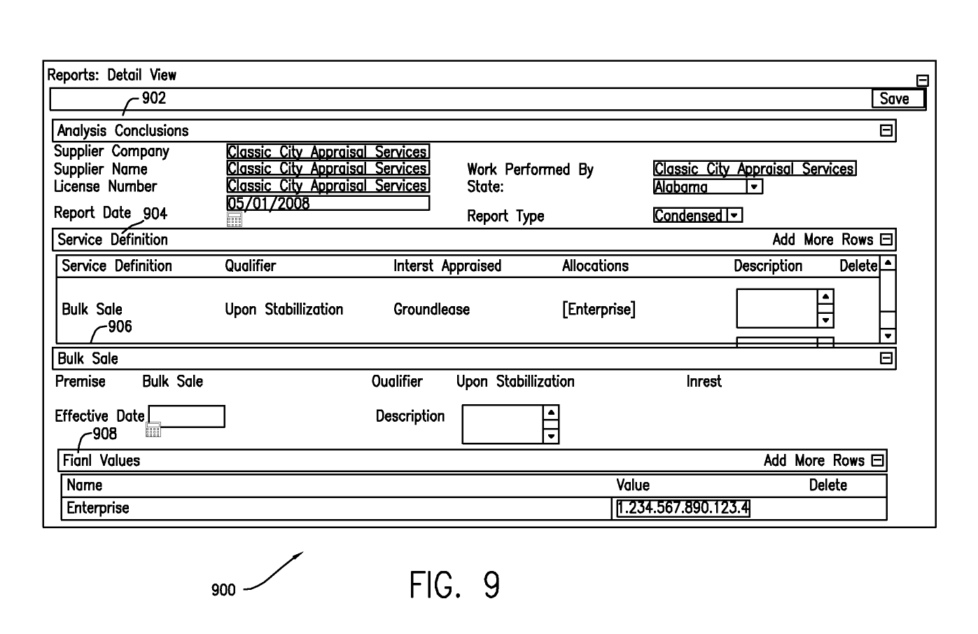

FIG. 9 shows a screen shot of a detail view 900 in response to selection of button 730, shown in FIG. 7. Detail view 900 may include analysis conclusion section 902, service definition section 904, whether the service is part of a bulk sale 906—i.e., does the service form part of an order for valuation services that includes more than one valuation, and final values 908.

The following table includes fields that may be sufficiently important as to make the fields mandatory in some embodiments, as shown in the following exemplary table, in the completion of a report for valuation according to the invention:

Appraisal Report

| | | | |
|---|---|---|---|
| AppContractNum | String | Mandatory | Can be a six digit |
| | | | number (Need to append |
| | | | zeroes) |
| CertificationNum | String | Mandatory | |
| CertificationState | String | Mandatory | |
| ReportType | String | Mandatory | |
| MRecentChgDate | Date | Mandatory | May be in the MM-DD- |
| | | | YYYY format. |
| ReportDate | Date | Mandatory | May be in the MM-DD- |
| | | | YYYY format. |
| ClientCompanyName | String | Mandatory | |
| PropertyName | String | Optional | |
| OwnerName | String | Mandatory | |
| PropertyAddress | String | Mandatory | |
| PropertyCountry | String | Mandatory | Can be validated |
| | | | against the database |
| | | | Should be an integer. |
| PropertyZip | Long | Mandatory | Can be validated |
| | | | against the database |
| PropertyState | String | Mandatory | Can be validated |
| | | | against the database |
| PropertyCounty | String | Mandatory | Can be validated |
| | | | against the database |
| PropertyCity | String | Mandatory | Can be validated |
| | | | against the database |

Mandatory/Optional Can be checked dynamically
based on the property type-sub type

| | | | |
|---|---|---|---|
| CurrentUse | String | Dynamic | |
| | | Checking | |
| ProposeBuildingUseChg | String | Dynamic | |
| | | Checking | |
| PropertyStatus | String | Dynamic | Can be validated |
| | | Checking | against the database |
| YearBuilt | String | Dynamic | Can be validated |
| | | Checking | against the database |
| PropertyTenancy | String | Dynamic | |
| | | Checking | |
| OccUnits | int | Dynamic | |
| | | Checking | |
| CurrentOccupancyPercent | int | Dynamic | |
| | | Checking | |
| Measurement | Template | Dynamic | |
| | | Checking | |
| CurrentListing | Y/N | Dynamic | |
| | | Checking | |
| CurListingPrice | double | Dynamic | |
| | | Checking | |
| NumBuilding | int | Dynamic | |
| | | Checking | |
| ParkingType | Y/N | Dynamic | |
| | | Checking | |
| Storeys | int | Dynamic | |
| | | Checking | |
| ParcelNum | long | Dynamic | |
| | | Checking | |
| LegalDesc | String | Dynamic | |
| | | Checking | |
| GroundLease | Y/N | Dynamic | |
| | | Checking | |
| SubsidizeLowIncomeTaxCredit | Y/N | Dynamic | |
| | | Checking | |
| BondFinancing | Y/N | Dynamic | |
| | | Checking | |
| Premise | Template | Optional | |

MEASUREMENT Template

| | | | |
|---|---|---|---|
| MeasurementType | String | Mandatory | Can be validated |
| | | | against the database |
| Quantity | int | Mandatory | |
| QuantityType | String | Mandatory | Can be validated |
| | | | against the database |
| AdditionalInfo | String | Optional | |

PREMISE Template

| | | | |
|---|---|---|---|
| ValueDefinition | String | Mandatory | |
| ValuePremise | String | Mandatory | |
| InterestAppraised | String | Mandatory | |
| Description | String | Mandatory | |
| EffectiveDate | Date | Mandatory | Can be of the MM-DD- |
| | | | YYYY format. |
| Allocation | Template | Optional | |
| ValueConclusion | Double | Mandatory | |
| CostAppUsed | Y/N | Mandatory | |
| LandValue | Double | Mandatory if | |
| | | CostAppUsed = ‘Y’ | |
| TotalImproveValueComp | Double | Mandatory if | |
| | | CostAppUsed = ‘Y’ | |
| SalesAppUsed | Y/N | Mandatory | |
| ContractSalePrice | Double | Mandatory if | |
| | | SalesAppUsed = ‘Y’ | |
| Measure | String | Mandatory if | |
| | | SalesAppUsed = ‘Y’ | |
| IncomeAppUsed | Y/N | Mandatory | |
| CapType | String | Mandatory if IncomeAppUsed = ‘Y’ | |
| NOI | Double | Mandatory if IncomeAppUsed = ‘Y’ | |
| ActOARRate | Double | Mandatory if IncomeAppUsed = ‘Y’ | |
| YieldRate | Double | Mandatory if IncomeAppUsed = ‘Y’ | |
| TerminalCapRate | Double | Mandatory if IncomeAppUsed = ‘Y’ | |
| AnalysisPeriod | Double | Mandatory if IncomeAppUsed = ‘Y’ | |
| ListingCmnt | String | Optional | |
| Deleted | Y/N | Optional | |

ALLOCATION Template

| | | | |
|---|---|---|---|
| AllocationType | String | Mandatory | Can be validated |
| | | | against the database |
| AllocationValue | Double | Mandatory | |
| Deleted | Y/N | Optional | |

Certain important points that may relate to the preceding table are as follows.

1) There should be only one “Appraisal Report” main tag;

2) The Date format can preferably be always “MM-DD-YYYY”;

3) The PropertyCountry, PropertyZip, PropertyState, PropertyCounty and PropertyCity can, and preferably should, be validated against a database;

4) The following list of tags can be checked dynamically to determine whether the tags are mandatory or not based on the property type and sub type: CurrentUse, ProposeBuildingUseChg, PropertyStatus, YearBuilt, PropertyTenancy, OccUnits, CurrentOccupancyPercent, Measurement, CurrentListing, CurListingPrice, NumBuilding, ParkingType, Storeys, ParcelNum, LegalDesc, GroundLease, SubsidizeLowIncomeTaxCredit, BondFinancing, Premises, and any other tags that may be added at the discretion of the administrator.

5) The Measurement and the Premise can be tags with sub tags. The requirement of the mandatory measurements and Premises can be checked dynamically.

6) In the Premises template, the CostAppUsed, SalesAppUsed and IncomeAppUsed fields can be made MANDATORY because they contain the information independent of whether any of the dependent tags are present or not;

7) For Deleting a Premises, the <Deleted> tag as ‘Y’ can be used along with the ValueDefinition, ValuePremise, InterestAppraised and Description tags as these are used to identify the Premises to be deleted;

8) Also the list of mandatory tags should preferably be included even if they are going to be deleted. While these tags may not be inserted into the database, however, they may be needed for validation;

9) The tags that are dependent on the CostAppUsed, SalesAppUsed and IncomeAppUsed tags may be checked, preferably only if they have the % Used tags value as ‘Y’; and

10) For deleting an Allocation, the <Deleted> tag as ‘Y’ may be used along with the Allocation Type.

Also the AllocationValue may be required for validation.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for valuation services information management have been provided. Persons skilled in the art will appreciate that the present invention can be practiced by other than the described embodiments, which are presented for purposes of illustration rather than of limitation, and the present invention is limited only by the claims which follow.

What is claimed is:

1. One or more computer-readable media storing computer-executable instructions which, when executed by a processor on a computer system, perform a method for managing valuation service information, the method comprising:
receiving a request for a valuation service that includes a group of properties;
validating the request;
determining whether the valuation request allows providing a real estate evaluation of the group of properties or requires a real estate appraisal of the group of properties;
if the valuation request allows providing a real estate evaluation of the group of properties, then implementing a direct award of the valuation service to a selected valuation service provider;
if the valuation request requires a real estate appraisal of the group of properties, then transmitting one of 1) a direct reward to a single appraisal provider and 2) a request for proposal (“RFP”) regarding the appraisal of multiple properties to a plurality of appraisal providers;
receiving bids from the appraisal providers in response to the RFP;
receiving reviews of the received bids; and
receiving a selection of a appraisal provider.

2. The method of claim 1 further comprising receiving evaluations for each of the properties in the group of properties.

3. The method of claim 2 further comprising adjusting at least a subset of the evaluations in response to market conditions.

4. The method of claim 2 further comprising adjusting each of the evaluations in response to property type with respect to the individual properties.

5. The method of claim 2 further comprising evaluating the evaluations based on a statistical analysis of a market for the properties.

6. The method of claim 1 further comprising notifying the selected appraisal provider.

7. The method of claim 1 further comprising providing a selectable criterion that allows a user to adapt the valuation criteria based at least in part on characteristics associated with the property being valued.

8. An apparatus for managing valuation service information, the apparatus comprising:
a workstation comprising:
a workstation storage device; and
a workstation processor connected to the workstation storage device, the workstation storage device storing a workstation program for controlling the workstation processor, the workstation processor operative with the workstation program to receive a request for a valuation service; and
a server operative to communicate with the workstation, the server comprising:
a server storage device; and
a server processor connected to the server storage device, the server storage device storing a server program for controlling the server processor, the server processor operative with the server program to receive values associated with market conditions and to adjust the evaluations in response to the received values.

9. The apparatus of claim 8 wherein at least one of the workstation and the server is further operative to receive a request for a valuation service that includes a group of properties.

10. The apparatus of claim 9, at least one of the workstation and the server further operative to receive individual evaluations for each of the properties in the group of properties.

11. The apparatus of claim 9, at least one of the workstation and the server further operative to implement adjustments to at least a subset of the evaluations for group of properties in response to values associated with market conditions.

12. The apparatus of claim 9, at least one of the workstation and the server further operative to evaluate the appraisals based on a statistical analysis of a market for the properties.

13. The apparatus of claim 9 wherein at least one of the workstation and the server is operative to evaluate the evaluations based on a statistical analysis of a market trend for the properties.

14. The apparatus of claim 8 wherein at least one of the workstation and the server is operative to notify the selected valuation service provider.

15. The apparatus of claim 8 wherein at least one of the workstation and the server is operative to provide a selectable criteria that allows a user to adapt a valuation criterion in response to a parameter of a property being valued.

16. One or more computer-readable media storing computer-executable instructions which, when executed by a processor on a computer system, perform a method for managing valuation service information, the method comprising:
receiving a request for a valuation service that includes a group of properties;
validating the request;
transmitting a request for proposal (“RFP”) regarding the request for valuation service for multiple properties to a plurality of valuation service providers;
receiving bids from the valuation service providers in response to the RFP;
receiving reviews of the received bids; and
receiving a selection of a valuation service provider.

17. The method of claim 16 further comprising receiving individual evaluations for each of the properties in the group of multiple properties.

18. The method of claim 17 further comprising adjusting at least a subset of the evaluations in response to market conditions.

19. The method of claim 17 further comprising adjusting each of the appraisals in response to property conditions with respect to the individual properties.

20. The method of claim 17 further comprising evaluating the evaluations based on a statistical analysis of a market for the properties.

21. The method of claim 17 further comprising evaluating the evaluations based on a statistical analysis of a market trend for the properties.

22. The method of claim 16 further comprising notifying the selected valuation service provider.

23. The method of claim 16 further comprising providing a selectable criterion that allows a user to adapt the valuation criteria based at least in part on characteristics associated with the property being valued.
